(19) United States
(12) Patent Application Publication
(10) Pub. No.: US 2023/0273868 A1
(43) Pub. Date: Aug. 31, 2023

(54) A DISASTER RECOVERY SYSTEM AND METHOD

(71) Applicant: ENSUREDR LTD., Kfar Saba (IL)

(72) Inventors: Uri Shay, Raanana (IL); Erez Paz, Herzliya (IL)

(21) Appl. No.: 18/005,719

(22) PCT Filed: Jun. 18, 2021
(86) PCT No.: PCT/IL2021/050743

§ 371 Date: Jan. 17, 2023

Related U.S. Application Data
(60) Provisional application No. 63/052,131, filed on Jul. 15, 2020.

(51) Int. Cl. G06F 11/22

(52) U.S. Cl. CPC G06F 11/2215; G06F 11/2257

(57) ABSTRACT

A disaster recovery (DR) system and method configured to test and evaluate systems readiness and ability to recover while providing various management tools that can assist an administrator operating said DR system and method. Said DR system and method further enables automated fixing and testing procedures while maintaining real time, reliable and up to date backup solutions.

### FIELD OF THE INVENTION

The present invention relates to disaster recovery (DR) system and method and, more particularly but not exclusively, to a DR system and method that is configured to test and evaluate systems readiness and ability to recover.

### BACKGROUND OF THE INVENTION

Information Technology (IT) and Operational Technology (OT) systems have become increasingly critical to the smooth operation of an organization, and arguably to the economy as a whole. As a result, the importance of ensuring continued operation and rapid recovery of such systems upon failure, has also significantly increased. Preparation and means for the recovery of IT or OT systems involves a significant investment of time and money, with the aim of ensuring minimal loss in a case of a disruptive event.

A disaster recovery (DR) is a strategic security plan that seeks to protect an enterprise from the effects of natural or human-induced disasters, a DR plan/strategy aims to maintain critical functions before, during, and after a disaster event, thereby causing minimal disruption to operations and business continuity. A backup is the copying of data into a secondary form (i.e. archive file), which can be used to restore the original file in the event of a disaster. DR and data backups may go hand in hand to support operations and business continuity.

DR plan involves a set of policies, tools and procedures to enable the recovery or continued operation of technology infrastructure and/or systems following either a natural or human-induced disaster. A DR strategy may be focused on supporting critical operations or business functions while retaining or maintaining operations or business continuity. This involves keeping all essential aspects of an operation or a business functioning despite a significant disruptive event/s.

Common DR strategy may utilize a secondary site/recovery site that contains backup data and is located at a separated location from the original operational site or at the same location of the operational site. Secondary sites represent an integral part of a DR strategy and a wider business continuity planning of an organization.

A secondary site may be another data-center operated by the same organization, or contracted via a service provider that specializes in disaster recovery services and may be located in a location where an organization can relocate following a disaster event. In some cases, one organization may have an agreement with a second organization to operate a joint secondary site. In some cases, an organization may conduct a reciprocal agreement with another organization to set up a secondary site at each of their data centers.

Disaster events can interrupt an organization from operating normally and may be caused by various factors and circumstances. For example, natural disasters may include acts of nature such as floods, hurricanes, tornadoes, earthquakes, epidemics etc. which in turn may have an effect on an organization's computerized systems. Technological hazards may include failures of systems and structures such as pipeline explosions, transportation accidents, utility disruptions, dam failures, and accidental hazardous material releases. Human-caused threats include intentional acts such as active cyber-attacks against data or infrastructure, chemical or biological attacks, and internal sabotage.

DR control measures can be classified into the following three types:
Preventive measures—Controls aimed at preventing a disaster event from occurring.
Detective measures—Controls aimed at detecting or discovering unwanted disaster events.
Corrective measures—Controls aimed at correcting or restoring the system after a disaster event had already occurred.

A DR plan may dictate these three types of controls measures to be documented and exercised regularly using DR tests and may utilize strategies for data protection that may include:
Backups sent to an off-site secondary site at regular intervals.
Backups made on-site and automatically copied to an off-site secondary site location, or made directly to an off-site secondary site location.
Private cloud solutions which replicate the data into storage domains which are part of a cloud computing service.
Hybrid cloud solutions that replicate both on-site and to off-site secondary sites and provide the ability to instantly move operation to said sites, but in the event of a physical disaster, servers can be started-up using the cloud computing service as well.

It is not uncommon that businesses that have suffered a disaster to their system, applications infrastructure or databases (such as a malfunction of any kind, cyber-attack, etc.), and attempted recovery using currently available disaster recovery solutions, were faced with unsatisfactory results. For example, businesses may experience partial recovery which results in an inability to operate on the basis of backed-up and recovered data, or experience a general inability to function satisfactorily. A possible explanation for these unresolved malfunctions is the fact that their system relied on secondary sites containing only partial replication or a not sufficiently updated version of their production site. Other reasons may include database inconsistency, applications' inability to run due to incompatibility issues resulting from un-updated application's version, etc. All the reasons above may contribute to low rate of reliability or to systems not functioning properly upon a disaster event.

Such lack of reliable DR solutions may put businesses at high risk, moreover, such failures may result in business/organization having little faith in their DR readiness. Substantiating such faith may be obtained by testing recovery prior to the occurrence of a disaster and on a regular basis, although experience shows that most currently designed and practiced tests do not reliably foresee success of an actual DR event.

Having a DR strategy is often an essential requirement of an insurance policy formulated in order to provide coverage for possible costs of remediating a disaster event, for example, an insurance policy type of “a business interruption insurance” provides for remuneration compensate for lost revenue, normal operating expenses, and the cost of moving a business to a temporary location in a case of a disaster. The lack of reliable DR solutions causes such insurance premiums to increase resulting in higher operating expenses. Such a “vicious circle” may actually negate the main purpose of DR solutions which is to mitigate risks upon disasters. Thus, prior and regular DR testing is a common requirement by DR events' insurers.

Currently, organizations usually test their ability to recover on a periodical basis instead of on a constant manner and use manual procedures to do so. A periodic testing may require less resources, but the intervals between testing may cause missing backup of important data and manual tests are often very complex, bear a high cost since experienced crew must be paid to conduct them and not reliable enough since human error may occur during testing. Moreover, because businesses cannot turn all their data-center/system at once to check their recovery readiness, DR testing is carried out upon only partial segments of the secondary site. The decision which segment to test is not necessarily rationally regulated and may be subject to biases and external considerations. In effect, current DR systems test partial sporadic segments of the secondary site. Such testing do not represent a real disaster event and do not provide an effective indication as to the success of recovery upon real-life disaster event.

DR solutions usually provide disaster recovery test program. DR test program is typically tailored for the specific attributes of the production site and configured to be conducted upon the secondary site that serves as a replication of the production site. By executing DR tests upon a secondary site, a user may determine whether or not the operational site is properly prepared to withstand a disaster.

As previously disclosed, even the most thought-out DR strategy can't be proven valid until testing it. Testing a DR plan allows to identify any flaws and inconsistencies in a DR strategy, thus ensuring that any possible damage is predicted and prevented before an actual disaster can occur. Reviewing the DR strategy in the context of DR testing scenarios is highly advisable.

One way of conducting a DR plan is to manually go through all steps of the designed plan, test scenarios and discuss them in detail, however, this testing method provides only a basic view of how the DR process would go as the system is not actually tested in real-time.

DR testing may be manual and expensive and a typical DR plan will most likely be tested no more often than the law or insurance compliance rules require, if at all. For instance, if DR testing is limited to being an annual event, there is a high chance of test failure, since the system will most likely hasn't been updated for a long period of time during which it probably underwent application and infrastructure changes. Since infrequent DR testing leads to significant problems at every test, it is preferred to test the system more often in order to have fewer problems.

DR testing conducted by automated procedures, relieve a large amount of manual work off the DR testing crew, and in turn reduces the cost of DR readiness tests. Another benefit of DR testing by automated procedures is that DR testing can be run for subsets of the infrastructure without any impact on production sites, rather than needing to fail large numbers of applications at once for test purposes. As part of DR testing automated procedures, each application can be verified separately on its own. This practice further reduces the cost and negative consequences of testing for DR and assures readiness.

Reducing the complexity and cost of testing DR and make it a routine may have a lot of positive implications. Any issue uncovered by a routine DR testing can be addressed immediately, and the DR process can be re-executed until all problems are resolved. By having DR awareness part of everyday practice, an IT team can expose potential problems before they become actual problems.

A full-scale automated simulation DR testing which entails testing all components of the DR plan in the actual operational site/system is seldom being conducted. Such an automatic real-time test may be beneficial, but as per current systems it might also disrupt the production/operational process. Conducting an automated real-time test in a constantly updating secondary site allows testing the ability to respond to various kinds of DR scenarios and verify the validity of a DR strategy in order to ensure that even an unexpected disaster won't set the system back.

Some publications disclose the aforementioned drawbacks, for example, US2014258782 discloses a recovery maturity model (RMM) that is used to determine whether a particular production environment can be expected, with some level of confidence, to successfully execute a test for a DR event. However, said RMM represents the system readiness for a DR event testing and not the system ability to recover after a DR event has actually occurred. In other words, US2014258782 discloses an ongoing recovery readiness indication in order to assist an administrator in preventing future DR events and not a final recovery readiness score that calculated system ability to recover from an already occurred DR event.

Thus, there is a need to provide a readiness indication means that will be used to represent a DR system's weighted readiness score.

There is a further need to provide a mimic (replica) secondary site in order to perform testing without interrupting the normal operation of a production site.

There is also a need to turn on the entire system/data-center (production and secondary sites) simultaneously and connect the secondary site to a network de-facto, in order to test and verify the DR level.

There is Another need to perform scheduled automatic recovery tests in a secondary site simulating a production site.

There is a further need to provide various management tools that may assist an administrator operating said DR system and method.

### SUMMARY OF THE INVENTION

The present invention provides a DR system and method comprising a readiness indicator used to represent a DR system's readiness level based on gathering and calculating system resources and performances in order to provide a clear readiness indication score.

Said system and method may further comprise a secondary site that represents a mimic of the production site such that incidents discovered in the secondary site will also occur in the production site.

Said system and method may further comprise an ability to turn on the entire system/data-center (production and secondary sites) simultaneously.

Said system and method may further comprise an ability to turn on a secondary site and connect it to the network de-facto. Said secondary site may comprises a data-center, servers, applications, databases, resources, web portals etc.

Said system and method may further comprise an ability to schedule automatic recovery tests in a secondary site that simulates a production site.

Said system and method may further comprise various management tools that can assist an administrator operating said DR system and method. Among such management tools are weekly reports platform and an online dashboard configured to clearly represent various parameters of a monitored system.

The current invention provides a recovery readiness indicator used to represent a DR system's recovery readiness level based on gathering and calculating system resources and performances in order to provide a clear recovery readiness indication score.

The current invention provides a weighted recovery time score used to represent an estimation of the time left until a full recovery of the DR system.

The current invention provides a business risk score (BRS) indicator indicating a final assessment of a business risk level.

The current invention provides a resiliency score indicator (RSI) used as a representation aid for the DR system and method and provides a calculated score representing a general system resilience in case of disaster events.

The current invention provides an automated fixing mechanism used to conduct autonomous fix operations of an identified malfunction. Said fixing mechanism is configured to be executed prior to an actual disaster event or, alternatively, during an actual disaster event.

The current invention provides a method for conducting cyber security tests that may be conducted without disrupting or adversely affecting the operation of the production site.

The current invention provides a secondary site that represents a mimic of the production site such that incidents discovered in the secondary site will also occur in the production site. Such an arrangement enables reliable testing without interrupting normal operation.

The current invention provides an ability to turn on the entire system/data-center (production and secondary sites) simultaneously, in order to test the DR readiness level. Such an ability also aids in understanding how a DR system behaves when stressed in unusual ways.

The current invention provides a DR system and method that can turn on a secondary site and connect it to the network de-facto. Said secondary site may comprises a data-center, servers, applications, databases, resources, web portals etc. Such switching-on of said secondary site may be conducted without disturbing the regular current operation of the original system/operational site.

The current invention provides scheduled automatic recovery tests in a secondary site that simulates a production site. Automatic recovery tests enable the identification and resolution of malfunctions prior or after an actual disaster event by operating the secondary site periodically and automatically, (for example, on a weekly basis) such that if a disaster scenario does occur, the organization will still be able to function properly, with no risk of significant down time.

The current invention provides various management tools that can assist an administrator operating said disaster recovery system and method. Among such management tools are weekly reports platform and an online dashboard configured to clearly represent various parameters of a monitored system.

The following embodiments and aspects thereof are described and illustrated in conjunction with systems, devices and methods which are meant to be exemplary and illustrative, not limiting in scope. In various embodiments, one or more of the above-described problems have been reduced or eliminated, while other embodiments are directed to other advantages or improvements.

According to one aspect, there is provided a disaster recovery (DR) system, comprising a controller configured to conduct recovery tests upon a secondary site, wherein the secondary site is configured to be a real-time replication of a production site, and wherein the recovery tests are configured to be conducted prior to an actual disaster event.

According to some embodiments, the production site and the secondary site are configured to be turned on simultaneously.

According to some embodiments, the DR system is configured to operate upon an aftermarket replication product.

According to a second aspect, there is provided a disaster recovery (DR) system, comprising a controller configured to gather various data regarding the ability of a secondary site to recover and further configured to use said gathered data to calculate and present at least one recovery readiness score (RRS) indicator indicating a final assessment of a recovery readiness level.

According to some embodiments, the at least one recovery readiness score (RRS) indicator is configured to display a one-value score.

According to a third aspect, there is provided a method for utilizing at least one recovery readiness score (RRS) indicator using a disaster recovery (DR) system, comprising the steps of conducting various tests regarding the operation of applications included in sections or a whole secondary site, collecting specific data related to disaster recovery (DR) parameters of applications included in sections or a whole secondary site, collecting specific data relating to disaster recovery (DR) parameters of sections or a whole secondary site, analyzing the data collected in accordance with previous steps using a designated algorithm, and presenting at least one final combined score indicating a recovery readiness level of sections or a whole secondary site.

According to some embodiments, the utilization of the RRS indicator includes using default weight values for the various tests.

According to some embodiments, the various tests are various workflow issues having default weight values.

According to some embodiments, the various tests are various system applications having default weight values.

According to some embodiments, a test result calculated as part of the utilization of the RRS is conducted using the formula: [(Number of intact tests/number of total tests)*100]*default weight value.

According to some embodiments, the total RRS is calculated by adding up all calculated tests results and divide value by the total summed-up weight value of said tests.

According to some embodiments, the analysis is conducted in accordance with specific customer requirements.

According to some embodiments, the analyzed data is also used to improve the operation of the production site.

According to some embodiments, the at least one recovery readiness score RRS indicator may be presented as part of a dashboard graphic display comprising various score metrics representations.

According to some embodiments, the at least one recovery readiness score RRS indicator is calculated using an AI algorithm.

According to a forth aspect, there is provided a method for operating an automated fixing mechanism using a disaster recovery (DR) system, comprising the steps of identifying a malfunction affecting a system ability to recover and function in case of a disaster event, determining a suitable fix to be conducted using a dedicated algorithm, and conducting an autonomous fix operation of the identified malfunction.

According to some embodiments, identifying a malfunction is conducted using an AI model.

According to some embodiments, the autonomous fix operation is conducted before or after a disaster event has occurred.

According to some embodiments, the autonomous fix operation is conducted using an auto-script or an AI model.

According to some embodiments, the training of the AI model is conducted using an internet sourced data-set or an in-system self-accumulated data-set.

According to some embodiments, the in-system self-accumulation dataset is constructed in accordance with the system production site.

According to some embodiments, the training of the artificial intelligence (AI) is conducted using a sandbox security procedure.

According to some embodiments, the autonomous fix operation is configured to operate in real-time while the secondary site operates as a real-time functioning replication of a production site.

According to some embodiments, the autonomous fix operation is configured to fix hardware and software malfunctions.

According to a fifth aspect, there is provided a method for utilizing at least one weighted recovery time score, using a disaster recovery (DR) system, comprising the steps of measuring at least one actual down-time caused by a disaster event affecting a DR system, replacing the system production site with a system secondary site in real time, performing a calculation using the at least one down-time measurement to form a combined value indicating a recovery time actual (RTA), comparing the RTA with a recovery time objective (RTO) to determine at least one weighted recovery time score, and presenting the at least one weighted recovery time score to a user.

According to some embodiments, the method for utilizing at least one weighted recovery time score can be conducted simultaneously upon multiple secondary sites.

According to some embodiments, a user determines the desired RTO in accordance with various parameters/preferences.

According to some embodiments, the at least one weighted recovery time score may be presented as part of a dashboard graphic display comprising various score metrics representations.

According to some embodiments, the at least one weighted recovery time score is calculated using an AI algorithm.

According to a sixth aspect, there is provided a method for calculating and displaying at least one real down time measurement (RDT) indicator using a disaster recovery (DR) system, comprising the steps of summing a system's recovery point actual (RPA) and recovery time actual (RTA), forming an RDT score and presenting the resulted RDT to a user.

According to a seventh aspect, there is provided a method for conducting security tests using a disaster recovery (DR) system, comprising the steps of establishing a secondary site representing a functioning replication of a production site, conducting various security tests using the secondary site, wherein said security tests are conducted without disrupting or adversely affecting the operation of the production site.

According to some embodiments, a third-party product provider is involved in conducting said security tests and may be an anti-virus product provider.

According to some embodiments, the various security tests are conducted during a DR event.

According to an eighth aspect, there is provided a method for utilizing security tests using a disaster recovery (DR) system, comprising the steps of using a data mover located at the production site to create a virtual machine (VM) located at the secondary site in order to run a failover test, and using a data mover located at the secondary site to create virtual machine controller (VMC) located at a bubble network in order to run another failover test.

According to some embodiments, the failover tests run by the VM and the VMC are different security applications.

According to some embodiments, the different security applications are antivirus products.

According to some embodiments, the VMC is configured to conduct automatic tests.

According to some embodiments, the data mover may be a service offered by an external provider.

According to some embodiments, the method further comprising replicating a data controller to the bubble network in order to authenticate processes and resolve queries.

According to some embodiments, a detailed report to be shown to a user is prepared in accordance with the tests results.

According to some embodiments, the VMC is copied to the bubble network using a hypervisor.

According to a ninth aspect, there is provided a method for utilizing a cleanup process of a disaster recovery (DR) system, comprising the steps of using a virtual machine (VM) located at the secondary site to instruct a data mover to run a cleanup process that includes erasing all servers from the secondary site in order to create an updated copy of the production site.

According to a tenth aspect, there is provided a disaster recovery (DR) system, comprising a controller configured to gather various data regarding potential risks that may affect the DR system and further configured to use said gathered data to calculate and present at least one business risk score (BRS) indicator indicating a final assessment of a business risk level.

According to an eleventh aspect, there is provided a method for utilizing at least one business risk score (BRS) indicator using a disaster recovery (DR) system, comprising the steps of conducting various tests regarding the operation of sections or the whole DR system, collecting specific data related to tested operation parameters of sections or the whole DR system, collecting specific data relating to factors that may affect the DR system, analyzing collected data and tests results conducted in accordance with the previous steps by using a designated algorithm, and presenting at least one final combined score indicating a business risk score of sections or a whole DR system.

According to some embodiments, the factors are global events or human induced events.

According to some embodiments, the at least one business risk score BRS indicator is calculated using an AI algorithm.

According to a twelfth aspect, there is provided a method for utilizing at least one resiliency score indicator (RSI) using a disaster recovery (DR) system, comprising the steps of calculating a score derived from both calculated recovery readiness score (RRS) and business risk score (BRS) using a designated algorithm, and presenting at least one final combined RSI indicating a resiliency level of sections or a whole DR system.

According to some embodiments, the RSI may be calculated by performing an average calculation of the RRS and the BRS of a DR system.

According to some embodiments, the at least one RSI is calculated using an AI algorithm.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention.

In the Figures:

FIG. 1A schematically illustrates a recovery readiness score indicator that may be used as a representation aid for a DR system and method, according to some embodiments of the invention.

FIG. 1B constitutes a flowchart diagram illustrating a method of utilizing a recovery readiness score, according to some embodiments of the invention.

FIG. 2 illustrating an automated fix mechanism, according to some embodiments of the invention.

FIG. 3 constitutes a flowchart diagram illustrating a method of utilizing an automated fix mechanism, according to some embodiments of the invention.

FIGS. 4A, 4B and 4C constitute a flowchart diagram illustrating a method of utilizing a weighted recovery time indicator that may be used as a representation aid of the DR system and method, according to some embodiments of the invention.

FIGS. 5A and 5B schematically illustrate and constitute a flowchart diagram illustrating a method for conducting cyber security tests, according to some embodiments of the invention.

FIG. 6 schematically illustrates a method of fail over, test, cleanup and report to be utilized using a DR system and method, according to some embodiments of the invention.

FIG. 7 schematically illustrates the communication protocols and infrastructure of a DR system and method, according to some embodiments of the invention.

FIG. 8 schematically illustrates a business risk score indicator that may be used as a representation aid for a DR system and method, according to some embodiments of the invention.

FIG. 9 schematically illustrates a resiliency score indicator that may be used as a representation aid for a DR system and method, according to some embodiments of the invention.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Unless explicitly stated, the method embodiments described herein are not constrained to a particular order or sequence. Additionally, some of the described method embodiments or elements thereof can occur or be performed simultaneously, at the same point in time, or concurrently.

The term “Controller”, as used herein, refers to any type of computing platform or component that may be provisioned with a Central Processing Unit (CPU) or microprocessors, and may be provisioned with several input/output (I/O) ports, for example, a general-purpose computer such as a personal computer, laptop, tablet, mobile cellular phone, controller chip, SoC or a cloud computing platform.

The term “Production site” as used herein, refers to the any operating computation system that plays a part in the operation on a business/organization. Said system may include the use of computers to store, retrieve, transmit, and manipulate data or information. A production site may be, for example, an information system, a communications system or, processing system, etc. operated automatically or by a group of users. A production site may be physically located in a particular site or may be a cloud-computing based system.

The term “Secondary site” as used herein, refers to a data site different from the user's current production site. A secondary site allows an organization to recover and resume operation following a disaster event at its operation site. A secondary site may be internal to an organization or provided by external providers and may be physically located near the production site or in a remote location. A secondary site may be physically located in a particular site or may be a cloud-computing based system.

The term “Real-time replication” as used herein, refers to an ability of a secondary site to represent as a “mirror site” of a production site wherein said mirror copy may also be updated in real-time in accordance with possible updates affecting the production site.

The term “Mirror site” as used herein, refers to a replica of the data and comprising another computation system, data-center or any network node representing a production site. Such a mirror site may host identical or near-identical content as its production site. A mirror site may provide a real-time backup of the production site.

The term “Bubble network” as used herein, refers to a virtual machines (VMs) that remain isolated from the physical network. Bubble networks are used in test-and-development labs and DR tests.

The term “Recovery tests” as used herein, refers to various drills and procedures used to examine computerized systems' ability to be restored in case of an actual disaster. Since the effectiveness of a DR strategy can be impacted by the inevitable changes to hardware and software architectures, varying application versions, etc., ongoing and regular testing is a necessity. Some examples for common recovery tests are walk through tests, simulation tests, parallel tests, cutover tests, etc. Said tests may test various operational processes and parameters such as data verification, database mounting, single machine boot verification, Single Machine Boot with Screenshot Verification, DR Runbook Testing, Recovery Assurance testing, etc.

The term “Recovery time actual (RTA)” as used herein, refers to an actual measurement of the critical metric for business continuity and disaster recovery. The RTA may be established during exercises or, alternatively, during an actual disaster event.

The term “Recovery time objective (RTO)” as used herein, refers to a targeted duration of time within a computerized system that serves a business/organization must be restored after a disaster (or any disruption) has occurred in order to avoid unacceptable consequences associated with a break in business continuity. In accepted business continuity planning methodology, the RTO is established by a system administrator that identifies time frames for necessary workarounds.

The term “Recovery point actual (RPA)” as used herein, refers to an actual measurement of the critical metric of the time period wherein data might be lost from a computerized system due to a disaster event. The RPA may be established during exercises or, alternatively, during an actual disaster event.

The term “Recovery point objective (RPO)” as used herein, refers to the maximum targeted period in which data might be lost from a computerized system due to a disaster event. RPO is calculated as part of business continuity planning. RPO may be considered as a complement of RTO, with the two metrics describing the limits of “acceptable” or “tolerable” level of computerized systems in terms of data lost or not backed up during that period of time (RPO), and in terms of the time lost (RTO) from a normal business process. The RPO may be calculated based on the production environment with its physical servers/virtual servers/networking/storage, etc. and based on the implemented replication solution that will replicate the data and servers to the DR site.

The term “Artificial intelligence” or “AI”, as used herein, refers to any computer model that can mimic cognitive functions such as learning and problem-solving. AI can further include specific fields such as artificial neural networks (ANN) and deep neural networks (DNN) that are inspired by biological neural networks.

The term “Failover mode” as used herein, refers to partial or complete relocation of a system operation from a production site to a DR site that holds a standby infrastructure and copies of the data and applications. A decision to move to a failover mode may be complex and involve many data movers/apps. Such a decision also requires considering a long list of parameters and may be performed either automatically or by manual means.

A. Ex Ante Recovery Tests

According to some embodiments, a disaster recovery (DR) system and method may comprise a controller configured to conduct recovery tests upon a secondary site while the secondary site is configured to be a real-time replication of a production site.

According to some embodiments, the DR system may be configured to operate upon an aftermarket replication product. Such replication product may be, for example, a replication product that use synchronous or a-synchronous replication.

According to some embodiments, during synchronous replication, data is written to a target data object on a secondary site while simultaneously being written to the corresponding source on a production site, allowing to attain the lowest possible RTO and RPO. This type of disaster recovery replication approach may be executed for high-end transactional applications and high-availability clusters requiring instant switch to a failover mode.

According to some embodiments, although a production site and its replication in a secondary site are kept synchronized as part of the synchronous replication, a data transfer latency may be created and slows down the app being synchronized. Yet, a synchronous replication product allows a reliable operation switch to the secondary site almost instantly and without data loss.

According to some embodiments, during a-synchronous replication, data is written to a secondary site only sometime after it has been written to a production site. The disaster recovery replication of the data occurs in set intervals (once a minute, ten minutes, an hour, etc.), according to a set schedule. According to some embodiments, a-synchronous replication may be a favorable approach in case a network bandwidth cannot support the pressure of synchronous replication, in other words, if the change rate of a mission-critical data constantly exceeds its rate of transfer to the secondary site.

According to some embodiments, a DR system configured to operate upon an aftermarket replication product may conduct various tests upon a secondary site, whether created by synchronous or a-synchronous replication, and may also present various operational data to a user.

According to some embodiments, recovery tests conducted by the DR system may be configured to be executed prior to an actual disaster event or, alternatively, during an actual disaster event. This can be achieved by the use of artificial intelligence (AI) that may provide an ability to anticipate and apply an automated fixing mechanism prior to a disaster event and following preliminary sighs of an upcoming malfunction.

According to some embodiments, an AI algorithm embedded in the DR system may be trained in order to make predictions or decisions without being explicitly programmed to perform a certain task. For example, an artificial neural network (ANN) may be trained to identify minute signs indicating system instability following a possible cyber-attack. The autonomous fixing mechanism may then provide a solution using the already trained model, thus, preventing a disaster event about to happen.

According to some embodiments, the autonomous fixing mechanism may be activated after a detection of a disaster event. For example, an AI algorithm or, alternatively, a data-center that stores vast database regarding common threats/malfunctions may be utilized in order to fix an already occurred disaster event.

According to some embodiments, in a case of a disaster event affecting a production site, a process of “true or live recovery” may be applied. Said true recovery process may be completely autonomous and operated by the DR system. for example, a certain organization may have multiple servers forming its production site, in a case of an ongoing disaster event, the DR system may give priority to recover the most essential applications forming the data center affected. According to some embodiments, said live recovery process may also be conducted as part of a DR simulation.

B. Recovery Readiness Score/Indicator

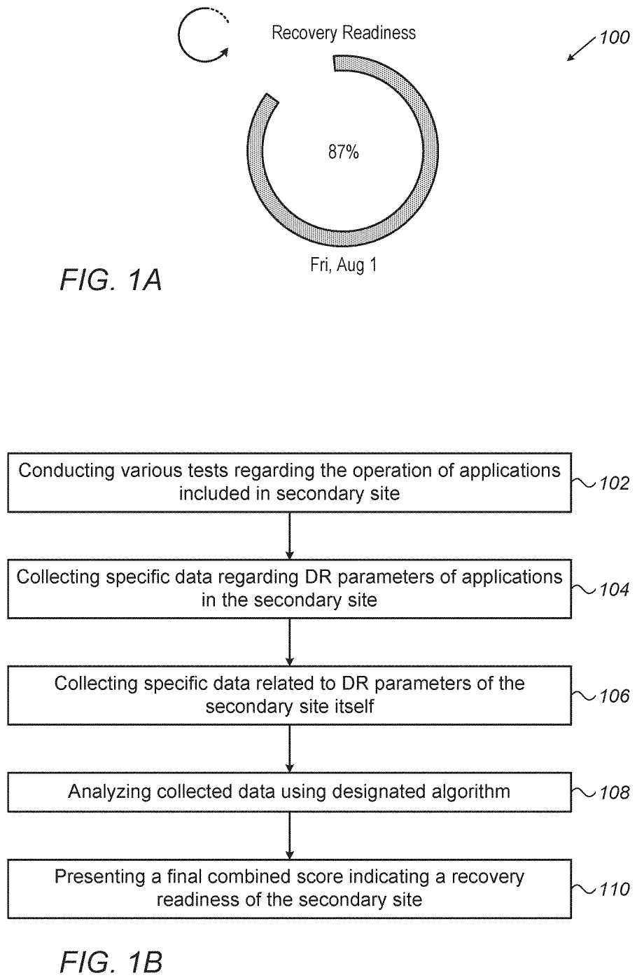

Reference is now made to FIG. 1A which schematically illustrates a Recovery Readiness score Indicator RRS 100 that may be used as a representation aid for a DR system and method. As shown, RRS indicator 100, may represent the gathering of various parameters and criteria that agglomerated together to provide a calculated score representing the system's ability to recover in case of a disaster event. For example, a RRS indicator 100 indicating the score 87%, means that 13% of the system resources/capabilities will not be available upon recovery pursuant to a disaster event.

Further examples for calculations and tests conducted to create a hypothetic RRS are disclosed in the paragraphs and charts below:

CHART 1.1

| Test | Weight |
|---|---|
| Applications | 25 |
| Data bases | 25 |
| Advance tests | 10 |
| Server tests | 10 |
| RTO | 20 |
| Total AntiVirus Disk IOPS | 5 |
| Total AntiVirus CPU | 5 |
| Total AntiVirus RAM | 5 |
| Network devices | 5 |
| Firewall devices | 5 |
| Branch offices | 5 |
| Internet connections | 5 |
| Workflow Issues | 15 |

According to some embodiments, each test in chart 1.1 is defined by a default weight score creating the total RRS calculation. Default weights values may change in accordance with various needs and constrains.

According to some embodiments, the calculation of the total RRS for applications, data bases, advance tests, server tests, network devices, firewall devices, branch offices, internet connections, etc. may be conducted using the following formula:

RRS (for each test)=(Number of intact tests/number of total tests)*100, and then multiplying the result with the default weight value.

CHART 1.2

| Workflow issue | Weight |
|---|---|
| FailOver issues | 60 |
| CleanUP issues | 30 |
| DC Clone issues | 60 |
| CleanUP timeout | 20 |
| EDRC engine 2 issues | 50 |
| EDRC network issues | 40 |
| EDRC 2nd IP issue | 30 |
| EDRC E2 timeout | 30 |
| Servers test had issues | 30 |

According to some embodiments, a workflow is a sequence of tasks that processes a set of data. Workflows occur across every kind of business or organization having a data center as part of its production site. According to some embodiments, each workflow issue in chart 1.2 is defined by a default weight value in order to calculate an RRS for each workflow issue which, in turn, will be used to calculate a total RRS. The default weights values may change in accordance with various needs and constrains.

CHART 1.3

| Test | Amount | Ok | Bad | Calc | Score | weight | Calc |
|---|---|---|---|---|---|---|---|
| Applications | 10 | 10 | 0 | (10/10)*100 | 100 | 25 | 2500 |
| Data bases | 5 | 5 | 0 | (5/5)*100 | 100 | 25 | 2500 |
| Advance tests | 12 | 6 | 6 | (6/12)*100 | 50 | 10 | 500 |
| Server tests | 20 | 14 | 6 | (14/20)*100 | 70 | 10 | 700 |
| RTO | 30:45 | X | X | (30/45)*100 = 66 | 100 | 20 | 2000 |
| | | | | (<90%) | | | |
| Total AntiVirus | 2000:5000 | X | X | (2000/5000)*100 = | 100 | 5 | 500 |
| Disk IOPS | | | | 44 (<80%) | | | |
| Total AntiVirus | 1500:6000 | X | X | (1500/6000)*100 = | 100 | 5 | 500 |
| CPU | | | | 25 (<80%) | | | |
| Total AntiVirus | 2900:3000 | X | X | (2900/3000)*100 = | 0 | 5*2 | 0 |
| RAM | | | | 96 (>95%) | | | |
| Network devices | 5 | 5 | 0 | (5/5)*100 | 100 | 5 | 500 |
| Firewall devices | 5 | 4 | 1 | (4/5)*100 | 80 | 5 | 400 |
| Branch offices | 5 | 5 | 0 | (5/5)*100 | 100 | 5 | 500 |
| Internet | 2 | 4 | 1 | (4/5)*100 | 80 | 5 | 400 |
| connections | | | | | | | |
| DC Clone issues | X | X | X | X | X | 60 | |
| Summery | | | | | 870 | 190 | 11,000 |

According to some embodiments, the parameters in chart 1.3 are used in the calculation of a hypothetic total RRS. For example, 10 applications (first column of chart 1.3) are tested and the results indicate that all 10 applications operate satisfactory, the calculation then conducted is (10/10)*100 and the result is score 100. The predetermined weight of said test is 25, hence, the applications calculation result is 2500, and so on.

In other words, each score is multiplied by a corresponding weight value then add up all calculated results and divide value by the total summed-up weight values.

For example, and in accordance with table 1.3:

11,000/190=results in 57% Recovery Readiness Score RRS.

According to some embodiments, the processing of RRS indicator 100 may be utilized using several different parameters, for example: system applications' ability to recover, server's status, database ability to recover, critical resources, actual time to recover, etc. According to some embodiments, an algorithm may be used to combine said parameters, while giving different weight to each parameter, and may also be used to generate a single score representing a business ability to recover.

According to some embodiments, the calculation may use an artificial intelligence (AI) algorithm that may provide an ability to apply complex calculations in order to combine said parameters, while giving different weight to each one of them. According to some embodiments, the AI algorithm embedded in the DR system may be trained in order to make predictions or decisions without being explicitly programmed to perform a certain task. For example, artificial neural network (ANN) may be trained to apply complex calculations upon said parameters.

According to some embodiments, an overall RRS may display the readiness level of a whole system, meaning, the overall readiness score regarding the ability of an entire system controlling a business/organization to recover in case of a disaster event. According to some embodiments, a specific RRS may be calculated and presented for any specific application comprising a business/organization' overall computerized system. Various specific RRS may be presented to a user in order to provide RRS data for specific applications of interest.

According to some embodiments, a calculation of a RRS may be conducted simultaneously upon multiple secondary sites, in order to allow a simultaneous monitoring of more than one system that undergo a disaster event.

According to some embodiments, the RRS indicator 100 provides a business/organization an efficient and fast recognition of a its ability to recover as well as the resilience level of its DR data backup. Although there is no single measurement for a certain system recoverability, and in contrast to other indication means known in the field, the RRS indicator 100 presents a one-value score which is not subject to interpretation and further analysis.

According to some embodiments, said RRS indicator 100 may be presented as part of a dashboard graphic display comprising various score metrics representing the operation of a monitored system. According to some embodiments, said dashboard graphic display can display a concise visual of DR parameters of a computerized system, for example, a typical dashboard graphic display may display several RRS indicators 100, recovery time indicators 300 along with tasks list, periodic statistics, resources allocation, etc. Such a display may provide a user with a centralized summery that enables quick detection and monitoring.

According to some embodiments, a RRS indicator 100 may be calculated for different sections of the same system, for example, a RRS indicator 100 may be calculated for different internal sites forming a single system.

According to some embodiments, the RRS indicator 100 represents the average percentage of the following resources: applications, databases, advanced servers, RTO, Resource Allocation, Network tests+various importance levels calculated weights.

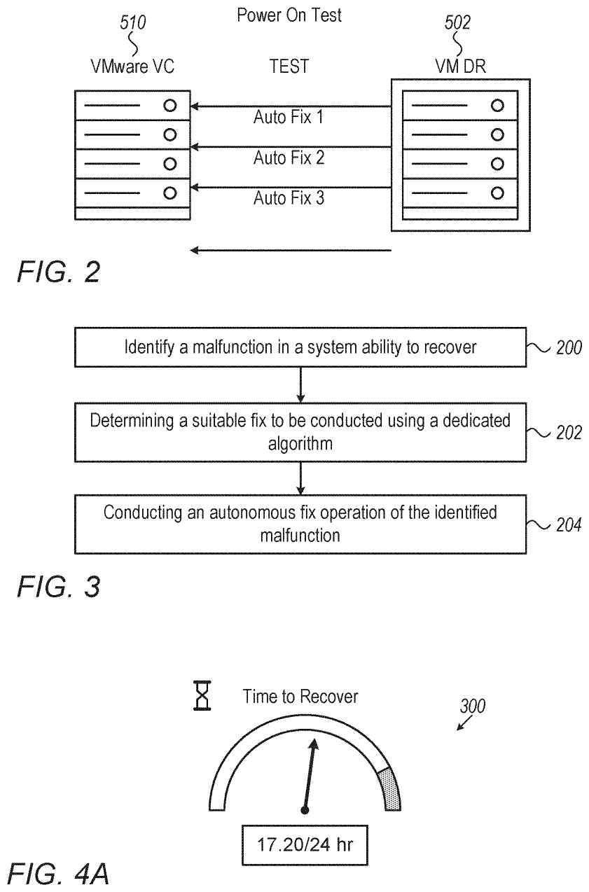

Reference is now made to FIG. 1B which constitutes a flowchart diagram illustrating a method of utilizing a recovery readiness score RRS, according to some embodiments of the invention. As shown, in operation 102 various tests regarding the operation of applications included in a secondary site may be conducted, for example: walk through test, simulation tests, parallel tests, cutover tests, etc. Said tests may test various operational processes and parameters such as data verification, database mounting, single machine boot verification, single machine Boot with Screenshot verification, DR runbook testing, recovery assurance testing, etc. In operation 104 specific data regarding the disaster recovery (DR) parameters of various applications in the secondary site is gathered. In operation 106 specific data relating to DR parameters of the secondary site itself is collected. The collected database can be used in the utilization of an AI algorithm embedded in the DR system and configured to, for example, perform autonomous fixing to various detected malfunctions (further elaborated in FIGS. 2 and 3). In operation 108 the collected data is analyzed using a designated algorithm. In operation 110 at least one final combined score indicating the recovery readiness level of the secondary site is presented to the user. According to some embodiments, the data analysis in operation 108 is conducted in accordance with specific customer requirements and the analyzed data may also be used to improve the operation of the production site. According to some embodiments, the data analysis in operation 108 is conducted using an AI algorithm and the analyzed data may also be used to improve the operation of the production site. In operation 110 a final combined score resulted from the aforementioned steps is presented to a user as the recovery readiness score RRS of the system/part of the system/process.

C. Autonomous Auto-Correction

Reference is now made to FIG. 2 which illustrating an autonomous fixing mechanism, according to some embodiments of the invention. Said autonomous fixing mechanism is configured to be activated prior to a disaster event and following preliminary sighs of an upcoming malfunction, or may be utilized in order to fix an already occurred disaster event. As shown, virtual machine (VM) 502 may conduct various tests (such as Auto fix 1, Auto fix 2, etc.) upon a DR site using a hypervisor 510 such as VMware VC. According to some embodiments, such tests may be conducted using a self-learning AI model such as ANN, DNN, etc. as further discloses hereinafter. According to some embodiments, such tests may be conducted using an auto-script resulting in autonomous operation of tasks instead of being executed one-by-one by a human operator as further discloses hereinafter.

Reference is now made to FIG. 3 which constitutes a flowchart diagram illustrating a method of utilizing an autonomous fixing mechanism, according to some embodiments of the invention. As shown, in operation 200 a malfunction in a system ability to recover is identified. According to some embodiments, such identification may be conducted by analyzing a failure data log. According to some embodiments, such identification may be conducted using a self-learning AI model such as ANN, DNN, etc.

In operation 202 a suitable fix is determined using an algorithm. According to some embodiments, said algorithm may be used to solve recovery malfunctions and/or offer solutions, for example, in case of failed tests said algorithm may conduct repeated tests, start a server that failed to power on, shutdown windows firewall if network test failed, start an application service if test fails, etc. According to some embodiments, said dedicated algorithm may be an AI algorithm embedded in the DR system and configured to conduct autonomous fixing of various detected malfunctions. An AI algorithm embedded in the DR system may be trained in order to make predictions or decisions without being explicitly programmed to perform a certain task. For example, artificial neural network (ANN, DNN, etc.) may be trained to identify minute signs indicating system instability due to a possible cyber-attack. The automated fixing mechanism may then provide a solution for said detected malfunction. Thus, preventing a disaster event from happening.

According to some embodiments, the autonomous fixing mechanism may also be activated after a detection of a disaster event. For example, an AI algorithm or, alternatively, a datacenter that stores vast database regarding common threats/malfunctions may be utilized in order to fix an already occurred disaster event.

In operation 204 the identified malfunction may be autonomously fixed. According to some embodiments, said autonomous fixing may be conducted after a disaster event has been detected or prior to a detection of such an event in order to prevent its occurrence. According to some embodiments, said autonomous fixing may be conducted using an AI algorithm as previously disclosed. According to some embodiments, the autonomous fixing mechanism is able to detect both hardware and software faults within a target system, repair faults with minimal crew intervention, and take proactive steps to prevent potential future failures.

According to some embodiments, the aforementioned operations provide an efficient and reliable procedures for overcoming dysfunctional situations and ensure that businesses will be able to function in case of a disaster. In other words, the goal of said fixing mechanism is to limit a disturbed-operation time caused by a disaster event to a minimum. Said minimum time may be defined by every business/organization in accordance with its unique need and field of operation. For example, a financial business expected to provide its customers with an ability to buy and sell stocks without delay, may set a minimum time that is lower from an organization that does not function under similar expectations.

According to some embodiments, the automatic fixing mechanism may be conducted using an auto-script resulting in autonomous operation of tasks instead of being executed one-by-one by a human operator. A fixing auto-script may be programed to autonomously fix various dysfunctions in a system. For example, A fixing auto-script may be a server-side JavaScript code that can run after an application is installed or upgraded. A fixing auto-scripts may be used to make changes that are necessary for the data integrity or product stability of an application.

According to some embodiments, the use of an artificial intelligence (AI) model in an auto-fix engine provides a significant ability to protect systems suffering from recovery issues. The use of AI may also provide the ability to keep pace with an ever-evolving threats and disasters landscape. For example, the use of AI such as ANN, may provide an evolving self-learning model that can autonomously adapt itself to upcoming threat (as previously disclosed), hence the use of AI approach may make redundant the “arms race” between hackers and developers while still providing sufficient protection. Moreover, the automated fixing mechanism powered by an unsupervised AI may respond to threats before they develop into a critical malfunction.

According to some embodiments, the training of the AI model may be conducted using internet sourced data-sets in accordance with their relevancy to particular disasters types, or alternatively, the training of the AI model may be conducted within the system self-accumulated data-sets. According to some embodiments, an AI autonomous fixing mechanism may be controlled from a central database which operates in real-time to deal with evolving disasters. AI autonomous fixing is also a self-learning technology, similar to the human immune system, it learns from the data and activity that it observes in-situ and in light of various probability-based calculations in accordance with evolving situations.

D. Mitigating Operational Threats

According to some embodiments, running an active secondary site having real-time replication ability is similar to running a “third production site”. In such a close environment, businesses can run penetration test, anti-virus, sandbox (which provides testing in an environment that isolates untested code changes and outrights experimentation from a production site), etc. These close environment tests do not affect the production site and hence, they can be conducted without a risk of system freezing or shutdown at the production site itself.

According to some embodiments, the fixing mechanism is configured to operate in real-time while the secondary site operates as a real-time functioning replication of a production site. A functioning secondary site can essentially be defined as a secondary data-center that runs de-facto, for example, turns on the servers, applications, databases, resources, web portals, connect the environment to network, etc. In other words, a real-time functioning replication secondary site works in a high degree of coordination with a production site. Such operation of a secondary site is conducted without disturbing the regular current operations of the original production systems.

E. Real-Time Responsiveness

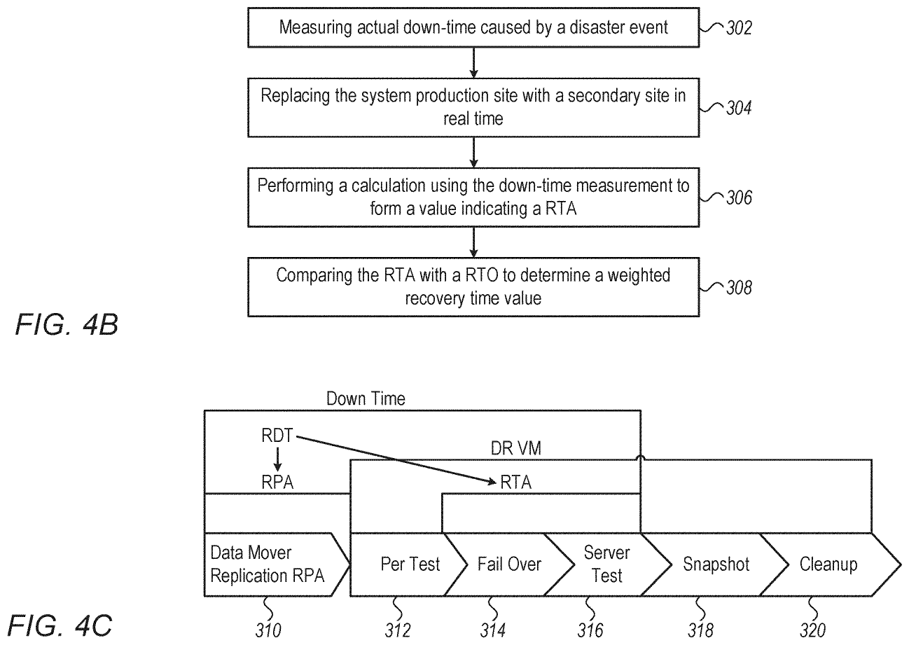

Reference is now made to FIGS. 4A, 4B and 4C which illustrate a method of utilizing a weighted recovery time indicator 300 that may be used as a representation aid of the DR system and method. According to some embodiments, weighted recovery time indicator 300 represent an estimation of the time left until a full recovery of the system. Time to actual recovery (RTA) is a significant value proposition of a recovery readiness platform provided by the current invention and essential in order to calculate the weighted recovery time indicator 300. In many cases, when disaster occurs, an organization has one chance to recover, and frequently, when a disaster recovery team's major concern is the time a business will be shut down in the event of a disaster. RTA estimation value is a weighted metric used to assess the success or failure of an organization's disaster recovery program (DRP). A recovery point actual (RPA) is also a significant value proposition of a recovery readiness platform provided by the current invention.

As shown in FIG. 4B, in operation 302 the actual down-time caused by a disaster event is measured, in other words, the time since a disaster event has caused a malfunction is measured by the DR system and up until when system returns to a normal operability. According to some embodiments, more than one down time can be measured, for example, in case of monitoring more than one system in a case that several systems may comprise a cluster of systems that controls the operation of a business/organization.

In operation 304 the system production site is replaced with the functioning secondary site in real-time by redirecting the network. according to some embodiments, the secondary site may be internal to an organization or provided by external providers and may be physically located near the production site or at a remote location or may be a cloud-computing based system. Said replacing may be conducted in order to provide a reliable representation of the malfunctioned production site.

In operation 306 a calculation is performed using the at least one down-time measurement to form a value indicating a recovery time actual (RTA). According to some embodiments, the RTA metric quantifies the “down time” in any environment and for any group of servers, applications or databases by using various connector servers. Each connector server reports to a smart stopwatch which gathers all measurements to a total result. According to some embodiments, and depending on a disaster recovery strategy, a user can enable all the connectors across all sites (production or secondary), or leave them disabled on the secondary sites until an incident occurs. According to some embodiments, when a secondary site becomes active, one of the connectors servers becomes active and start to gather data from the operational site. If the active connector fails, another connector remains available to gather data.

In operation 308 the RTA calculated in operation 306 is compared with a recovery time objective (RTO) to determine a weighted recovery time value to be presented to a user as part of the weighted recovery time score indicator 300.

According to some embodiments, said weighted recovery time score may be calculated for different sections of the same system, for example, a weighted recovery time score may be calculated for different internal sites forming a single system.

According to some embodiments, the DR system and method may simulate a real disaster and test the servers and applications, by an internal “stop watch” that measures the organization's RTO. This affords an organization a unique view of its system by allowing it to get a real estimation and provide the ability to compare their planned RTO with their RTA. According to some embodiments, the RTO may be determined by a user in accordance with various parameters/preferences.

According to some embodiments, each operation 302-308 can be performed automatically. According to some embodiments, the actual time to recover indicator 300 may give different results during a day, hence providing organizations the ability to test recovery times at specific hours, a capability which cannot be efficiently perform manually.

According to some embodiments, operation 302-308 can be conducted simultaneously upon multiple secondary sites, this ability allows a simultaneous monitoring of more than one system that undergo a disaster event.

As shown in FIG. 4C, and according to some embodiments, summing the RPA and RTA may form a new score: Real Down Time measurement (RDT) which represents the general time to recovery. The RDT also depends on a few factors such as the Data Mover Replication/Recover Point Appliance (RPA) 310 that may affect the RPO, (the stronger/faster it is, the RPO value is expected to decrees). The RTA may be calculated as a result of a fail over 314 and a server test 316. According to some embodiments, the RDT may be represented to a user as a combined visual indicator. According to some embodiments, during a real RD event only stages 310, 314 and 316 are conducted, and stages per test 312, snapshot 318 and cleanup 320 are conducted only when the DR system undergoes a simulation.

F. Cyber Security Tests

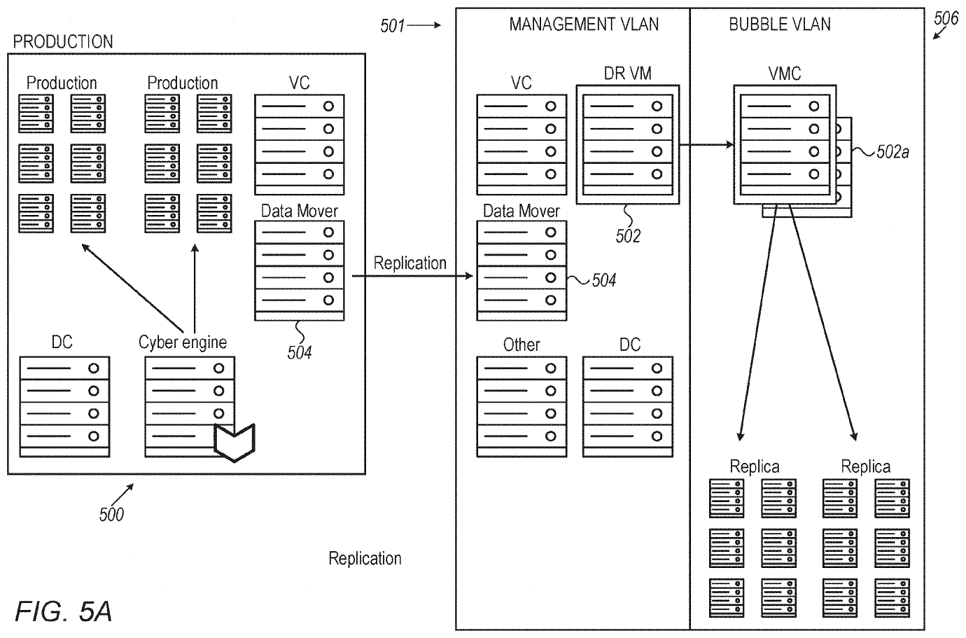

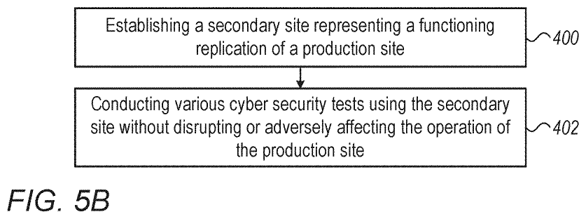

Reference is now made to FIGS. 5A and 5B which schematically illustrate and constitute a flowchart diagram illustrating a method for conducting cyber security tests, according to some embodiments of the invention. As shown in FIG. 5A, the data mover 504 (a component that runs its own operating system) is located within the production site 500 and may be replicated to DR site 501 using another data mover 504 located within the DR site 501. According to some embodiments, virtual machine (VM) 502 virtually located at the DR site 501 may run a failover test that may include using an antivirus software or any other security software, and virtual machine controller (VMC) 502a located at the bubble network 506, may run a failover test that may include using another antivirus software or any other security software. For example, VM 502 may use McAfee antivirus and VMC 502a may use Norton antivirus. In this way, a greater security level may be achieved since different security software are operating on either the DR site 501 or on the bubble network 506, resulting in greater coverage and enhanced ability to detect possible threats.

As shown in FIG. 5B, in operation 400 a secondary site representing a functioning secondary site replication in real-time of a production site is established. According to some embodiments, said secondary site may mimic the production site in an exact manner, such that every data or operation, comprises or conducted within the production site has an equivalent in the secondary site. In operation 402 various cyber security tests may be conducted using the secondary site. According to some embodiments, said cyber security tests may be conducted without disrupting or adversely affecting the operation of the production site.

According to some embodiments, cyber security tests may be conducted during a DR event, since an ongoing DR event affecting a system may trigger cyber-attacks. The reason for a higher risk of cyber-attacks occurring during a DR event, is a higher system vulnerability caused by the disaster event and can provide ways of penetrating a usually secure system. According to some embodiments, a third party may be involved in conducting the aforementioned security tests, for example, an anti-virus product of an external provider may be integrated with the DR system and perform said security tests.

According to some embodiments, the DR system and method may be configured to work with or “ride on” a variety of replication products/services, for example, a DR system and method may fully integrate with a replication product, making it easy to manage disaster recovery tests automatically and to obviate the need to manually test dozens or hundreds of servers. The integration with a replication service may also reduce the associated complexity and risk of DR failure and the error list of manual DR tests.

G. Fail Over Procedures

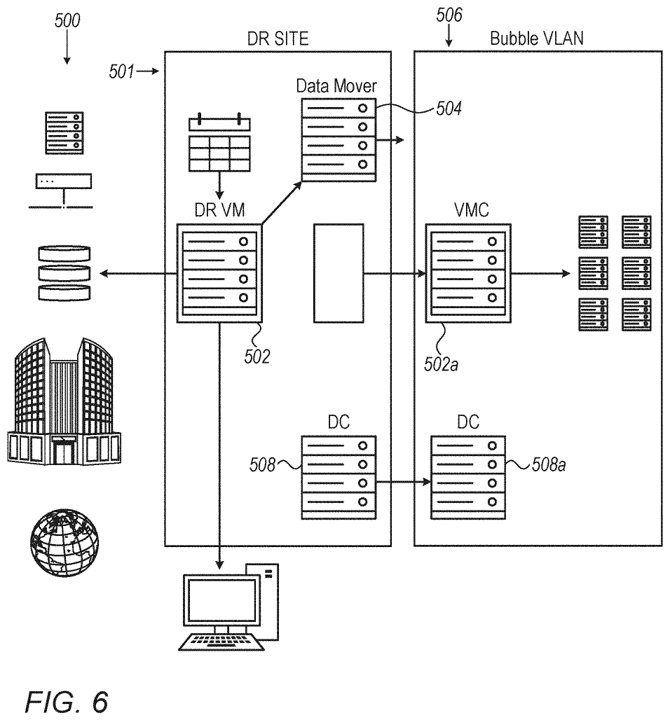

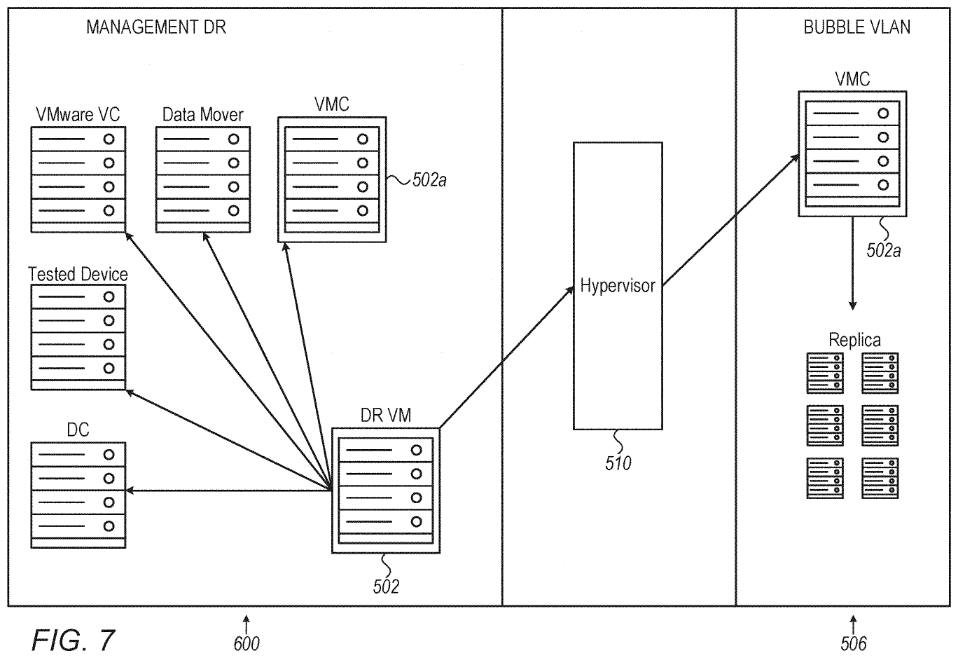

Reference is now made to FIG. 6 which schematically illustrates a method of fail over, test, cleanup and report to be utilized using the DR system and method. According to some embodiments, FIG. 6 shows a production environment 500 comprises physical servers, virtual servers, networking or any kind of storage media. According to some embodiments, VM 502 is virtually located within the DR site 501 and in charge of the workflow of the DR site 501. VM 502 may use data mover 504 to create VM controller (VMC) 502a virtually located within a bubble network (VLAN) 506 in order to test applications and servers. According to some embodiments, VMC 502a may be configured to conduct automatic tests such as, for example, failover tests, and the data mover 504 may be any provider offering DR services. According to some embodiments, an adaptor or multi adaptor (not shown) is configured to communicate with the data mover 504. According to some embodiments, data controller 508 is also being replicated to bubble network 506 to form data controller 508a in order to authenticate processes and to resolve any DNS queries.

According to some embodiments, the VMC 502a is configured to test the servers and VM 502 is configured to test all of the devices such as physical servers, networking, storages, branch offices, etc. at the end of the test, a detailed report with the test results may be created. According to some embodiments, the result may be observed by the user using the online dashboard configured to clearly represent various parameters of a monitored system. According to some embodiments, a recovery readiness score 100 (previously disclosed) that reflects the recovery reediness level may be calculated on the basis of the aforementioned tests.

According to some embodiments, FIG. 6 also illustrates a cleanup and report process configured to erase all the servers in the DR site 501 in order to create an updated copy of the production site 500 within the DR site 501 and bubble network 506. According to some embodiments, VM 502 instructs the data mover 504 to run the cleanup process and the data mover 504 is configured to constantly update the DR site 501 and bubble network 506. According to some embodiments, VM 502 is configured to clean up the domain controller 508 from the bubble network 506. At the end of this process, a report may be generated and sent to the user.

H. Communication Protocols

Reference is now made to FIG. 7 which schematically illustrates the communication protocols and infrastructure of a DR system and method, wherein the DR site 600 (or secondary site) comprises the core components of a DR site. According to some embodiments, VMC 502a is copied to the DR site 600 from the VM 502 and also copied to the bubble network 506 using the hypervisor 510. According to some embodiments, the hypervisor 510 may be any known mediator platform that manages virtual servers such as VMware, etc. According to some embodiments, VM 502 is being constantly sampled during testing operation such that the exact testing end time point is known in real-time.

I. Business Risk Score/Indicator

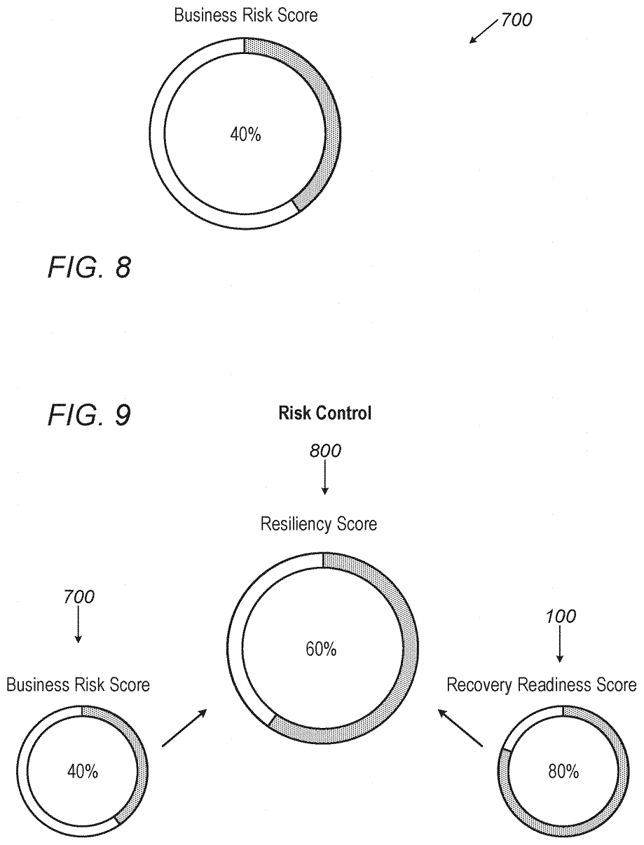

Reference is now made to FIG. 8 which schematically illustrates a Business Risk Score indicator or BRS indicator 700 that may be used as a representation aid for the DR system and method. As shown, a BRS indicator 700, may represent the gathering of parameters and criteria that agglomerated together to provide a calculated score representing a business risk score in case of various disaster events.

As previously disclosed, any business or organization may be exposed to disaster events affecting its data center and operation wherein said events may be caused by various physical factors or may result from various human causes. Such an uncertainty regarding future threats triggers a need to try and estimate the probability that a certain data center will suffer a disaster and present the results to a user of a DR system.

There a further need to decide whether or not to move to a failover mode in case of an ongoing disaster event. One way to do so is to apply a range of thresholds set by each organization in order to define a checklist that may provide guidance whether or not to move to a failover mode. One downside of such method is that these thresholds are varied, vague and in many cases hard to comprehend in case of true live imminent disaster.

According to some embodiments, a unique scoring technique and visual indication has the ability to help an organization to understand how close are they to a true disaster event and when, if at all, to move to a failover mode.

As previously disclosed, BRS indicator 700 may be used as a representation aid for a DR system and method. For example, a BRS indicator 700 may show a score ranging from 0-100% in order to provide an organization with a clear pie chart representation summing up various risks. Such a clear representation may help a user to quickly understand and act to reduce potential risk by conducting any desirable action.

According to some embodiments, the algorithm used to perform the calculations needed in order to present a BRS indicator 700 uses two main inputs, the first is a global input that calculates variables concerning the global environment. Among such variables are location, weather, specific dates, distance from any potential facility or natural phenomena that may pose a risk (such as earthquake susceptible areas, volcanos, nuclear reactors, dams, etc.), geopolitics data, line of business statistics, power outages, etc.

According to some embodiments, global inputs may be updated by the user or may be autonomously updated by the DR system in accordance to various global events. For example, SARS-CoV-2 (COVID-19) pandemic is an external global event that may cause an increasing risk to businesses/organizations.

The second input is an infrastructure input that calculates variables concerning infrastructure used by the organization. Among such variables are maintenance mode, resources allocation, manpower, app/infra complexity, UPS state, monitoring tools, peak hours or peak dates, etc.

According to some embodiments, infrastructure inputs may be collected by inspection of the state of a data center infrastructure along with the operation of various applications. Infrastructure inputs may also be collected from the line of business and general state of the organization. For example, a sale season high on online sales may cause a load on infrastructure resource that may fail if not well maintained.

According to some embodiments, the aforementioned collected data may be stored, calculated and analyzed in order to present the BRS indicator 700. According to some embodiments, machine learning (ML) and artificial intelligence (AI) techniques may be used in the calculation and analysis of said data. For example, ML and AI models may be used to investigate and compare between twin companies around the world having the same line of business or same vendors, for application operation and infrastructure. Said AI induced comparison may be used to provide valuable predictions regarding possible risks, either global or infrastructure induced.

J. Resiliency Score/Indicator

Reference is now made to FIG. 9 which schematically illustrates a Resiliency Score Indicator RSI 800 and its formation, wherein said RSI 800 may be used as a representation aid for the DR system and method. As shown, RSI 800, may represent a combined score calculated in accordance with the combined values of RRS indicator 100 and BRS indicator 700 in order to provide a new calculated score representing a general system resilience in case of disaster events.

According to some embodiments, said agglomerated data creating the RSI 800 may be a part of a “risk control” visual indicia available to a user of the DR system. According to some embodiments, RSI 800 may be an average calculation of RRS indicator 100 and BRS indicator 700. For example, if RRS indicator 100 indicates 80% and BRS indicator 700 indicates 40%, RSI 800 will indicate 60% representing the total resilience level of the DR system. According to some embodiments, RSI 800 may be calculated by any calculation or algorithm, and may be produced as a result of applying AI or ML models on any gathered relevant data.

According to some embodiments, a service for “Disaster Insurance” may be provided for clients of the DR system and method, and said service may use unique indicators to valuate a business resiliency and by that calculating an exact insurance policy price, for example, a business that achieved a recovery readiness score of 97% will pay less than a business that achieved 60%, etc.

Although the present invention has been described with reference to specific embodiments, this description is not meant to be construed in a limited sense. Various modifications of the disclosed embodiments, as well as alternative embodiments of the invention will become apparent to persons skilled in the art upon reference to the description of the invention. It is, therefore, contemplated that the appended claims will cover such modifications that fall within the scope of the invention.

1. A disaster recovery (DR) system, comprising:
a controller configured to conduct recovery tests upon a secondary site,
wherein the secondary site is configured to be a real-time replication of a production site, and wherein the recovery tests are configured to be conducted prior to an actual disaster event.

2. The system of claim 1, wherein the production site and the secondary site are configured to be turned on simultaneously.

3. The system of claim 1, wherein the DR system is configured to operate upon an aftermarket replication product.

4. A disaster recovery (DR) system, comprising a controller configured to gather various data regarding the ability of a secondary site to recover and further configured to use said gathered data to calculate and present at least one recovery readiness score (RRS) indicator indicating a final assessment of a recovery readiness level.

5. The disaster recovery (DR) system of claim 4, wherein the at least one recovery readiness score (RRS) indicator is configured to display a one-value score.

6. A method for utilizing at least one recovery readiness score (RRS) indicator using a disaster recovery (DR) system, comprising the steps of:
(i) conducting various tests regarding the operation of applications included in sections or a whole secondary site,
(ii) collecting specific data related to disaster recovery (DR) parameters of applications included in sections or a whole secondary site,
(iii) collecting specific data relating to disaster recovery (DR) parameters of sections or a whole secondary site,
(iv) analyzing the data collected in accordance with steps i-iii using a designated algorithm; and
(v) presenting at least one final combined score indicating a recovery readiness level of sections or a whole secondary site.

7. The method of claim 6, wherein the utilization of the RRS indicator includes using default weight values for the various tests.

8. The method of claim 6, wherein the various tests are various workflow issues having default weight values.

9. The method of claim 6, wherein the various tests are various system applications having default weight values.

10. The method of any one of claims 6-9, wherein a test calculation is conducted using the formula: [(Number of intact tests/number of total tests)*100]*default weight value.

11. The method of claim 10, wherein the total RRS is calculated by adding up all calculated tests results and divide value by the total summed-up weight value of said tests.

12. The method of claim 6, wherein the analysis is conducted in accordance with specific customer requirements.

13. The method of claim 6, wherein the analyzed data is also used to improve the operation of the production site.

14. The method of claim 6, wherein the at least one recovery readiness score RRS indicator may be presented as part of a dashboard graphic display comprising various score metrics representations.

15. The method of claim 6, wherein the at least one recovery readiness score RRS indicator is calculated using an AI algorithm.

16. A method for operating an automated fixing mechanism using a disaster recovery (DR) system, comprising the steps of:
(i) identifying a malfunction affecting a system ability to recover and function in case of a disaster event,
(ii) determining a suitable fix to be conducted using a dedicated algorithm, and
(iii) conducting an autonomous fix operation of the identified malfunction.

17. The method of claim 16, wherein identifying a malfunction is conducted using an AI model.

18. The method of claim 16 wherein the autonomous fix operation is conducted after a disaster event has occurred.

19. The method of claim 16, wherein the autonomous fix operation is conducted before a disaster event has occurred.

20. The method of claim 16, wherein the autonomous fix operation is conducted using an auto-script.

21. The method of claim 16, wherein the autonomous fix operation is conducted using an AI model.

22. The method of claim 21, wherein the training of the AI model is conducted using an internet sourced data-set.

23. The method of claim 1921, wherein the training of the AI model is conducted using an in-system self-accumulated data-set.

24. The method of claim 23, wherein the in-system self-accumulation dataset is constructed in accordance with the system production site.

25. The method of claim 1921, wherein the training of the artificial intelligence (AI) is conducted using a sandbox security procedure.

26. The method of claim 16, wherein the autonomous fix operation is configured to operate in real-time while the secondary site operates as a real-time functioning replication of a production site.

27. The method of claim 16, wherein the autonomous fix operation is configured to fix hardware and software malfunctions.

28. A method for utilizing at least one weighted recovery time score, using a disaster recovery (DR) system, comprising the steps of:
(ii) measuring at least one actual down-time caused by a disaster event affecting a DR system,
(ii) replacing the system production site with a system secondary site in real time,
(iii) performing a calculation using the at least one down-time measurement to form a combined value indicating a recovery time actual (RTA),
(iv) comparing the RTA with a recovery time objective (RTO) to determine at least one weighted recovery time score, and
(v) presenting the at least one weighted recovery time score to a user.

29. The method of claim 0, wherein every step is performed automatically.

30. The method of claim 28, wherein the method can be conducted simultaneously upon multiple secondary sites.

31. The method of claim 28, wherein a user determines the desired RTO in accordance with various parameters/preferences.

32. The method of claim 28, wherein the at least one weighted recovery time score may be presented as part of a dashboard graphic display comprising various score metrics representations.

33. The method of claim 28, wherein the at least one weighted recovery time score is calculated using an AI algorithm.

34. A method for calculating and displaying at least one real down time measurement (RDT) indicator using a disaster recovery (DR) system, comprising the steps of summing a system's recovery point actual (RPA) and recovery time actual (RTA), forming an RDT score and presenting the resulted RDT to a user.

35. A method for conducting security tests using a disaster recovery (DR) system, comprising the steps of:
(i) establishing a secondary site representing a functioning replication of a production site,
(ii) conducting various security tests using the secondary site,
wherein, said security tests are conducted without disrupting or adversely affecting the operation of the production site.

36. The method of claim 35, wherein a third party product provider is involved in conducting said security tests.

37. The method of claim 35, wherein the third party is an anti-virus product provider.

38. The method of claim 35, wherein the various security tests are conducted during a DR event.

39. A method for utilizing security tests using a disaster recovery (DR) system, comprising the steps of:
(i) using a data mover located at the production site to create a virtual machine (VM) located at the secondary site in order to run a failover test, and
(ii) using a data mover located at the secondary site to create virtual machine controller (VMC) located at a bubble network in order to run another failover test.

40. The method of claim 35, wherein the failover tests run by the VM and the VMC are different security applications.

41. The method of claim 39, wherein the different security applications are antivirus products.

42. The method of claim 39, wherein the VMC is configured to conduct automatic tests.

43. The method of claim 39, wherein the data mover may be a service offered by an external provider.

44. The method of claim 39, wherein the method further comprising replicating a data controller to the bubble network in order to authenticate processes and resolve queries.

45. The method of claim 39, wherein a detailed report to be shown to a user is prepared in accordance with the tests results.

46. The method of claim 39, wherein the VMC is copied to the bubble network using a hypervisor.

47. A method for utilizing a cleanup process of a disaster recovery (DR) system, comprising the steps of using a virtual machine (VM) located at the secondary site to instruct a data mover to run a cleanup process that includes erasing all servers from the secondary site in order to create an updated copy of the production site.

48. A disaster recovery (DR) system, comprising a controller configured to gather various data regarding potential risks that may affect the DR system and further configured to use said gathered data to calculate and present at least one business risk score (BRS) indicator indicating a final assessment of a business risk level.

49. A method for utilizing at least one business risk score (BRS) indicator using a disaster recovery (DR) system, comprising the steps of:
(i) conducting various tests regarding the operation of sections or the whole DR system,
(ii) collecting specific data related to tested operation parameters of sections or the whole DR system,
(iii) collecting specific data relating to factors that may affect the DR system,
(iv) analyzing collected data and tests results conducted in accordance with steps i-iii by using a designated algorithm, and
(v) presenting at least one final combined score indicating a business risk score of sections or a whole DR system.

50. The method of claim 49, wherein the factors are global events.

51. The method of claim 49, wherein the factors are human induced events.

52. The method of claim 49, wherein the at least one business risk score BRS indicator is calculated using an AI algorithm.

53. A method for utilizing at least one resiliency score indicator (RSI) using a disaster recovery (DR) system, comprising the steps of:
(i) calculating a score derived from both calculated recovery readiness score (RRS) and business risk score (BRS) using a designated algorithm, and
(ii) presenting at least one final combined RSI indicating a resiliency level of sections or a whole DR system.

54. The method of claim 53, wherein the RSI may be calculated by performing an average calculation of the RRS and the BRS of a DR system.

55. The method of claim 53, wherein the at least one RSI is calculated using an AI algorithm.
